(19) United States
(12) Patent Application Publication
(10) Pub. No.: US 2003/0215592 A1
(43) Pub. Date: Nov. 20, 2003

(54) Imageable multi-wall elastic sleeves

(75) Inventors: Donald R. Gilde, Spicewood, TX (US); James L. Mayne, Cedar Park, TX (US); Steven D. Yau, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/145,277

(22) Filed: May 14, 2002

(51) Int. Cl. B32B 1/08

(52) U.S. Cl. 428/36.91

(57) ABSTRACT

A tubular article comprising a multi-wall extruded tube, one embodiment of which is a dual-wall extruded tube including an elastomeric outer wall having a first color and an elastomeric inner wall having a second color. The dual-wall extruded tube may be formed by co-extrusion of the elastomeric outer wall and the elastomeric inner wall to provide a bond between the two walls. Visible indicia may be formed in the tubular article by removal of selected portions of the elastomeric outer wall using laser ablation to reveal the second color of the elastomeric inner wall. The first color differs from the second color to provide high contrast of the indicia from the first color of the elastomeric outer wall. A tubular article according to the present invention is expandable for placement on a core member in an expanded condition wherein the bond between the elastomeric outer wall and the elastomeric inner wall remains substantially unchanged.

### BACKGROUND OF THE INVENTION

1. Field of the Invention

The invention relates to marking of elastomeric structures to provide identification for items placed in contact with the elastomeric structures. More particularly the present invention provides co-extruded, elastic multi-wall tubular structures including walls of contrasting color to form images by controlled laser ablation of portions of an outer wall to expose the contrasting color of an inner wall.

2. Description of the Related Art

Methods for applying identifying marks to components, products, systems and structures continue to evolve for improved efficiency, ease of mark recognition, and cost reduction. Identifying marks may be applied to a variety of substrates including, for example, paper, plastic and metal. Plastic substrates are important for labeling and marking insulated and jacketed conductor assemblies, such as those used in electrical distribution and optical communication systems, for example, to include bar codes, serial numbers, labels, company names and expiration dates and the like.

Methods such as pad printing, ink-jet printing, embossing and stamping have been used to mark plastic products. These methods suffer to varying degrees from problems including slow process rates, poor label or mark durability, causing marks to fade, and susceptibility to smudging and marring that render images illegible. Inked marks and labels are particularly susceptible to marring, smudging and solvent attack.

Laser beam printing may be used to overcome these problems, so that lasting marks may be applied to plastic substrates. The process of laser beam printing is a fast and relatively simple process for applying durable identifying marks and labels.

Known processes for laser imaging include those involving laser ablation of polymeric coatings and those suitable for thermo-chromic materials. The use of laser ablation to form identifying marks requires the use of a multi-layer composite that includes layers of contrasting colors. Selective removal of exposed layers, by laser ablation, reveals underlying layers of contrasting color. The contrasting colors reveal images, such as bar codes, produced by removal of selected portions of the outer layer.

The use of thermo-chromic materials as laser imaging substrates typically requires a coated composition containing one or more thermally reactive components that change color during exposure to the heat of a laser beam. Preferably the color change is permanent to overcome some of the problems discussed previously. Laser beam sensitive coating compositions typically contain materials that change color when raised to temperatures corresponding to the heat intensity of a focused laser beam. A thermo-chromic, laser responsive material may include a resin filled with a colorant, as described in published applications JP 2000309639, JP 20001011267, JP 11279292, JP 9302236, WO 9008805, and U.S. Pat. No. 5,578,120. Addition of black materials to resin compositions may be required to provide sufficient image contrast. Published applications JP 20001011267, WO 200024826, EP 710570 and U.S. Pat. No. 5,373,039 describe thermo-chromic compositions of this type. European published application EP 710570 includes laser markable, heat recoverable structures. Coating compositions including a resin binder and heat absorbing pigments and coated pigments also change color under the influence of laser light. Description of this type of coating appears in published applications, WO 9220526, U.S. 20010030179, and U.S. Pat. Nos. 5,630,979, 6,291,551 and 6,214,917.

Removal of material by laser ablation may be used as an effective way to produce durable and relatively permanent labels and identifying marks. Published application WO 01/45559 describes polymer coated articles that may be identified by selective ablation of the polymer coating. U.S. Pat. No. 5,061,341 provides a method for laser ablating a marking in a multi-layer coating. Removal of an outer layer reveals the contrasting color of an underlying layer to produce an image according to the laser pattern. U.S. Pat. No. 5,649,846 shows the use of laser imaging to produce a printing plate that includes image revelation due to color variation of the layers. Labeling of a work piece may be achieved using the method described in U.S. Pat. No. 6,007,929 wherein sequential coating of a topcoat and a contrasting basecoat on a work piece facilitates identification by ablation of the topcoat to reveal the basecoat. A label may be formed using the multi-layer structure described in U.S. Pat. No. 6,054,090 using laser ablation of an outer layer to show a contrasting color underlayer before the outer layer is fully dry. U.S. Pat. Nos. 6,165,594, 6,214,250 and 6,251,212 describe high temperature composite material labels exhibiting color contrast between a top layer and a fired ceramic body using selective laser ablation.

Regardless of previous uses of laser marking, other opportunities exist for permanent marking using laser ablation. In particular there is a need for durable labeling of wires, cables and wiring harnesses and the like to provide identification that resists attack by contaminants including biological and chemical agents present in extreme environments.

### SUMMARY OF THE INVENTION

The present invention satisfies the need for environmentally protected identifying structures suitable for use with electrical, telecommunications, optical fiber cables and assemblies and other tubular constructions such as SAS, chemical liquid piping systems. Laser ablation marking of elastomeric tubes provides sleeve identifiers. Sleeve identifiers according to the present invention may be held in an expanded condition, on a hollow core support. Installation of sleeve identifiers around a wire or cable or similar article involves e.g. placing the portion of a wire, to be identified, inside the hollow core and collapsing and removing the core to allow the elastic sleeve identifier to shrink its original dimensions. Elastic sleeves, of the type described, may be referred to herein as marker sleeves, cold shrink sleeves, pre-stretched tubes or the like.

Selection of the sleeve identifier dimensions and elastic properties ensures that upon shrinking there will be contact so that the sleeve grips the outer surface of a wire or cable to prevent ingress of contaminants between the two. Sleeve identifiers according to the present invention preferably comprise a co-extruded, dual wall, cold shrink sleeve including a thin outer wall over a thicker inner wall. The two walls have contrasting colors. Controlled laser ablation of the outer wall exposes the contrasting color of the inner wall to create identifying symbols such as alphanumeric and bar code symbols and the like.

The co-extruded, multi-wall, cold shrink sleeve identifiers previously described may include walls having any combination of colors provided there is sufficient color contrast between layers of the multi-walled structure to reveal a clearly discernable image. Preferred color combinations include a yellow or white thinner outer wall over a black inner wall. These combinations, subjected to laser marking, provide sleeve identifiers having high contrast black-on-yellow or black-on-white identification marks. Identification marks produced in this way maintain substantial permanence because the foreground color and the background color reside in adjacent layers. Image permanency also benefits from the formation of an embossed mark due to the fact that laser ablation creates shaped openings in an outer layer as it reveals the image-forming, contrasting color of the inner layer. Careful selection of elastomeric rubber compositions provides identifying marks having good abrasion resistance, fluid resistance and chemical resistance in comparison to conventional ink markings. Both black and colored rubbers, used in multi-walled sleeve identifiers according to the present invention may include components to limit fugitive contaminants that could be released by the heat of laser ablation. For example, preferred compositions are free from toxic compounds of either lead or antimony. Other additives may be included for flame retardancy and reduced staining.

Cold shrink identifier sleeves develop a dynamic liquid tight bond over substrates to resist fluid ingress and protect against attack by environmental agents including aggressive nuclear, biological and chemical agents associated with hazardous environments and unconventional agents that endanger human life.

More particularly the present invention provides a tubular article comprising a multi-wall extruded tube, one embodiment of which is a dual-wall extruded tube including an elastomeric outer wall from about 250 μm (10 mils) to about 625 μm (25 mils) thick, having a first color and an elastomeric inner wall from about 1.88 mm (75 mils) to about 3.75 mm (150 mils) thick, having a second color. The dual-wall extruded tube may be formed by co-extrusion of the elastomeric outer wall and the elastomeric inner wall to provide a bond between the two walls. Visible indicia may be formed in the tubular article by removal of selected portions of the elastomeric outer wall using laser ablation to reveal the second color of the elastomeric inner wall. The first color differs from the second color to provide high contrast of the indicia from the first color of the elastomeric outer wall. Preferred colorants for the elastomeric outer and inner walls include white pigments, colored pigments and carbon black. A tubular article according to the present invention is expandable for placement on a core member in an expanded condition wherein the bond between the elastomeric outer wall and the elastomeric inner wall remains substantially unchanged.

Extrudable elastomers suitable for use to form tubular articles include propylene diene monomer (EPDM) rubbers, silicone elastomers, fluorosilicone elastomers, fluoro-elastomers, and mixtures thereof and other types of vulcanized elastomers and thermoplastic elastomers. Selected elastomers have an elongation of 300% by application of force from about 1.72 MN/sq. meter (250 psi) to about 5.51 MN/sq. meter (800 psi), and a tensile strength at break from about 6.90 MN/sq. meter (1000 psi) to about 15.16 MN/sq. meter (2200 psi).

The present invention also includes a cold-shrink article comprising a support core, adapted to become a collapsed core, and a multi-wall elastic tube held in an expanded condition on the support core. The multi-wall elastic tube includes an elastomeric outer wall having a first color and at least one elastomeric inner wall having a second color. A multi-wall elastic tube may be formed by co-extrusion to provide interlayer bonding including the elastomeric outer wall and the at least one elastomeric inner wall. The multi-wall elastic tube has visible indicia formed therein by removal of selected portions of the elastomeric outer wall using laser ablation to reveal the second color of the at least one elastomeric inner wall. The first color differs from the second color to provide high contrast of the indicia from the first color of the elastomeric outer wall. A multi-wall elastic tube in its expanded condition maintains interlayer bonding between walls substantially unchanged. The multi-wall elastic tube shrinks, as the support core becomes the collapsed core.

Definition of Terms

Terms used herein have the meanings indicated as follows:

The interchangeable use of any of a number of terms including “marking sleeve,” “sleeve identifier,” “marker band” and “identification sleeve” and the like refers to an elastic strip or band, preferably a multi-layer strip or continuous band that has suitable properties of tensile and elongation for use as a cold-shrink article that may be held for a protracted time in expanded condition on a collapsible support core.

An article referred to as a “cold-shrink” or “pre-stretched” article is typically an elastic article supplied in an expanded condition on a relatively rigid support core that is adapted to collapse on demand. The support core dimensions exceed the dimensions of the elastic article in its relaxed condition so that collapse and removal of the core allows the elastic article to shrink to its relaxed condition. A sleeve identifier, as a cold shrink article, may be applied to a substrate, such as a wire or cable, by placing the substrate inside the support core before collapsing the core. Unlike a heat-shrink article, a cold-shrink article recovers its relaxed state under ambient conditions.

The term “multi-wall” preferably refers to a “dual wall” tubular structure formed by co-extrusion using known methods of co-extrusion. Suitable processing includes sequential and simultaneous co-extrusion.

Terms including “bond,” “bonding” and “interlayer bonding,” and the like refer to the strength of interfacial attachment between walls of a multi-walled structure formed by co-extrusion. Preferably interlayer fusion occurs during extrusion such that any inadvertent wall separation results from cohesive failure within a layer rather than adhesive failure at the interface between layers.

Use of the term “stenciled” signifies that at least one layer of a multi-layer or multi-wall structure has voids corresponding to the shapes of the identifying mark or code.

Terms including “high contrast” and “sufficient contrast” and the like refer to differences in colors contained within walls of multi-walled structures according to the present invention. Suitable color selection provides sufficient contrast so that each layer may be readily discerned from those adjacent to it. Formation of high contrast images or indicia results from removal, by laser ablation, of a colored outer layer to reveal a different colored inner layer giving sufficient contrast and legibility for visual observation and easy reading and scanning of an identifying mark or bar code with automatic detection equipment.

### DETAILED DESCRIPTION OF THE PREFERRED EMBODIMENT

Cable identifier sleeves according to the present invention, also referred to herein as sleeve identifiers and marker sleeves and the like, include co-extruded multi-wall structures comprising elastomeric rubbers of closely related composition. It is possible to produce co-extruded multi-walled structures as elastic composite tapes that may be applied to surface areas of suitable substrate structures by wrapping or using adhesive bonding or fusion bonding techniques. Elastomeric rubber compositions are selected to provide marker sleeves having concentric walls or layers differing in color from each other. Color selection provides sufficient contrast that each layer may be readily discerned from those adjacent to it.

Formation of identifying marks in multi-walled sleeves involves the selective, imagewise removal of material from outer walls to a depth that reveals the contrasting colors of underlying walls. The walls from which material was removed include multiple recesses causing them to have the appearance of a stenciled or embossed surface. A variety of methods may be used to accomplish this condition. The preferred method of material removal is laser ablation using a laser assembly controlled to produce the desired design of an identifying mark or bar code symbol. Mark formation by laser ablation and multi-wall construction distinguishes marker sleeves according to the present invention from heat recoverable articles that have a single wall including a thermo-chromic, laser markable composition, as described in EP 710570.

A preferred embodiment of a sleeve identifier according to the present invention is a co-extruded, dual wall sleeve or band including a thicker inner wall surrounded by a relatively thinner outer wall. Both walls comprise an elastomeric rubber compound of high elasticity to allow subsequent stretching of marker sleeves into an expanded condition. Retention of marker sleeves in a stretched condition is possible with collapsible, disposable cores that are commonly used in pre-stretched tubing (PST) products, also known as cold shrink products, that find use in electrical cabling applications. Products using expanded elastomeric sleeves were developed as protective covers to overcome disadvantages of heat shrink products, such as the potentially damaging effect of heat used to initiate recovery of a heat shrink cover.

Sleeve identifiers differ from conventional cold shrink tubes by including concentric walls formed by co-extrusion of elastomeric rubbers, preferably of similar composition. Typically PST products are single walled structures of uniform composition. It will be appreciated that multiple wall concentric tubes could fail by layer separation if they are highly stretched. The potential for interlayer separation has been used to advantage for co-extruded heat recoverable articles described in U.S. Pat. No. 4,656,070. In this case, a shrinkable tubular article includes a tubular inner elastomeric member held radially expanded by a relatively rigid, tubular outer member. A bond formed between the inner surface of the outer member and the outer surface of the inner member may be disrupted by application of solvent to allow the elastomeric member to peel away from the restraining outer member.

Failure or disturbance of interlayer bonding of extruded multi-wall sleeves is particularly undesirable according to the present invention. The requirements of interlayer bonding are such that the marker sleeves perform their intended function with substantially no loss of interlayer adhesion. Preferred embodiments exhibit cohesive failure within layers rather than adhesive failure at interfaces between layers. Optimum interlayer bonding during co-extrusion depends upon the use of extrudable compositions that are chemically compatible. Suitably selected materials produce extruded composites having interfacial material fusion between walls. Layer infusion of this type, during co-extrusion of separate feed-streams, produces composite tubes according to the present invention that maintain their structural integrity during expansion and formation of core-supported, pre-stretched identifier bands. Although not wishing to be bound by theory it is possible that the use of thermally curable elastomeric compositions contributes to further interlayer bonding during curing of multi-wall co-extruded tubes in steam heated autoclaves.

Cohesive failure of marker sleeves leads to loss of structural integrity that may be observed as rupture or splitting of the sleeves during expansion for placement on support cores or during storage of the sleeves in an expanded condition. Splitting and rupture of sleeve identifiers according to the present invention may be reduced to a minimum by careful control of co-extrudable compositions. Control of extrudable compositions may include changes in concentrations of components in elastomeric rubber compositions or adjustment of processing conditions in terms of extruder screw configurations, zone temperature adjustments and other aspects of extrusion processing to produce co-extruded multi-walled structures having desired levels of interlayer bonding.

Control of extrudable compositions stabilizes marker sleeves against layer separation and splitting or rupture. Composition adjustment may also be required for optimum performance in hazardous environments. Hazardous environments include those exposed to nuclear, biological and chemical (NBC) agents. Protection against attack of hazardous environments requires the use of materials and structures and marker systems that prevent entrapment of liquid and invasive powdered agents such as corrosive materials and highly toxic organic and biochemical agents. Stability is also required to decontaminating fluids for hazardous materials that may be deposited by various means on essential structures such as wires cables and harnesses, requiring identification of e.g. part numbers, serial numbers, date codes, and the like in equipment, vehicles and assemblies including those of the military. Extrudable elastomeric rubber compositions according to the present invention include those resistant to attack by extreme environments. This is demonstrated by evidence of continuing effective performance of sleeve identifiers exposed to extremes of temperature, humidity, chemical attack and water immersion. Marker sleeves according to the present invention survive extended testing at temperatures as low as about −50° C. (−60° F.) and as high as about 70° C. (160° F.) without failure. Exposure to multiple extended cycles between about 23° C. (73.5° F.) and 50% humidity and about 30° C. (86° F.) and 95% humidity produced no change in the appearance of material used for sleeve identifiers according to the present invention. Similarly chemical attack, using exposure of samples to liquids and vapors of gasoline, hydraulic fluid and cleaning solvent produced no change in appearance. Samples tested by immersion in water were impervious to fluid ingress.

Materials that may be co-extruded according to requirements of the present invention are typically highly elastomeric polymers, including both vulcanized elastomers and thermoplastic elastomers (TPE), having a Shore A scale hardness up to about 100. There is a substantially linear relationship between tensile modulus (defined in Rubber Industry terms as “Modulus of the Rubber”) and elongation. The slope of a plot of tensile vs elongation produces a line representing Young's modulus (E). E is approximately 3G, where G is the shear modulus of the material, which has an approximately linear relationship with Shore A hardness. Preferred values of G for elastomeric materials range from about 0.2 MN/sq meter to 5 MN/sq meter. This translates to a Shear modulus range of about 0.2 MN/sq meter (29 psi) to about 5 MN/sq meter (725 psi) or a Young's Modulus of about 0.6 MN/sq meter (87 psi) to about 15 MN/sq meter (2175 psi). Using a linear interpretation on these criteria gives a 100% rubber modulus value between about 0.6 MN/sq meter (87 psi) to about 15 MN/sq meter (2175 psi) and a 300% modulus range of about 1.8 MN/sq meter (261 psi)to about 45 MN/sq meter (6525 psi).

Preferred co-extruded tubes, for sleeve identifiers, exhibit rupture-free elongation of 100% by application of forces between about 0.62 MN/sq meter (90 psi) and about 2.07 MN/sq meter (300 psi) and rupture-free elongation of 300% by application of between about 1.72 MN/sq meter (250 psi) and about 5.51 MN/sq meter (800 psi). Suitable polymers further exhibit elongation at break between about 600% and about 1200%.

Useful polymers for co-extrusion of multi-walled tubing according to the present invention include ethylene propylene diene monomer (EPDM) rubbers, silicone elastomers, fluorosilicone elastomers, fluoro-elastomers, and others in the category of vulcanized elastomers and thermoplastic elastomers.

Extrusion Conditions

Coextrusion of multi-wall tubular structures according to the present invention uses conventional rubber extruders that are commercially available. Preferred extrusion conditions require barrel temperatures in the extruder feed section from about 50° C. (120° F.) to about 60° C. (140° F.), increasing to between about 70° C. (160° F.) and about 82° C. (180° F.) extruder head. A five zone extruder set-up typically includes individual zone settings such that Zone 1 is 50° C. (120° F.), Zone 2 is 55° C. (130° F.), Zone 3 is 60° C. (140° F.), Zone 4 is 65° C. (150° F.), Zone 5 is 70° C. 160° F. (Zone 5) and the extrusion head temperature is 82° C. (180° F.).

The use of a screen pack, at the extruder head, is preferred to filter out dirt and foreign material from the flowing rubber compound.

Extruded tubes comprise curable compositions that require curing under steam pressure in a steam autoclave. Depending on the steam pressure, which controls temperature, extruded rubber tubes undergo curing for about 5 minutes with 2 minutes purge under 1.24 MN/sq. meter (180 psi) steam. There is an inverse relationship of cure time and steam pressure.

Experimental

Rubber Compounding

Rubber compositions (see Table 1 and Table 3) according to the present invention were thoroughly mixed in a Banbury mixer heated between about 80° C. and 100° C. The mixed composition was then strained for uniformity using an 80 mesh screen.

Material Testing

Test slabs were prepared according to the ASTM standards identified in Tables 2, 4, 5 and 6. The test slabs were cured for 15 minutes at about 175° C. (350° F.) followed by conditioning at ambient temperature and a relative humidity between about 35% and about 65% for a minimum of 8 hours before testing.

Glossary:

BUNA EPT 6850 is EPDM rubber available from Bayer Corporation,

BUNA EPT 5459 is EPDM rubber available from Bayer Corporation,

N550 is carbon black available from Columbian Chemicals Company,

STRUKTOL WB-16 is a mixture of fatty acids available from Struktol Company,

HISIL 532 EP is precipitated silica available from PPG Industries Inc.,

GREAT LAKES DP-45 is a brominated aromatic ester available from Great Lakes Chemical Corporation,

ZINC OMADINE is a fungicide available from Arch Chemicals Inc.,

EF(VTMO)-50 is an organofunctional silane available from Elastochem Inc.,

PLC(SR297)-72 is 1,3 Butylene glycol dimethacrylate available from Rhein Chemie Corporation,

VANOX ZMTI is Zinc 2-mercaptotoluimidazole available from R. T. Vanderbilt Company, Inc.

VULCUP 40KE is a peroxide crosslinker available from Hercules Inc.

SUNFAST YELLOW 13 is a yellow pigment available from Sun Chemical Co.

NYACOL ZTA is antimony pentoxide available from Nyacol Nano Technologies Inc.

Table 1 and Table 2

Table 1 provides a typical composition for an elastomeric rubber used for an inner wall of identifier sleeves according to the present invention. Optimization of elastomeric rubber compositions requires variation of components to provide extruded materials having desired properties of modulus, elongation at break, and ability to form strong interfacial bonds with compatible, co-extruded elastomeric rubbers. Table 2 provides preferred test methods for property measurement and typical ranges for selected properties of co-extrudable elastomeric rubbers.

TABLE 1
BLACK RUBBER COMPOSITION

| | | Rubber | Component |
|---|---|---|---|
| Commercial Identity | Chemical Identity | phr | wt % |
| BUNA EPT 6850 | EPDM Rubber | 75 | 21.0 |
| BUNA EPT 5459 | EPDM Rubber | 50 | 14.0 |
| VANOX ZMTI | Zinc 2-mercapto | 1.25 | 0.4 |
| | tolumimidazole | | |
| N550 Carbon Black | Carbon Black (amor- | 33 | 9.3 |
| | phous) | | |
| STRUKTOL WB-16 | Proprietary mixture | 2 | 0.6 |
| Zinc Oxide | Zinc Oxide | 5 | 1.4 |
| HISIL 532 EP | Hydrated Amorphous | 50 | 14.0 |
| | Silica | | |
| NYACOL ZTA | Antimony Pentoxide | 16 | 4.5 |
| GREAT LAKES DP- | Bis(2-ethylhexyl) | 110 | 30.9 |
| 45 | tetrabromophthalate | | |
| ZINC OMADINE | Bis(1-hydroxy-2(1H)- | 0.3 | 0.1 |
| | pyridine thionato-O,S)- | | |
| | (T-4) Zinc | | |
| EF(VTMO)-50 | Silane in hydrocarbon | 2 | 0.6 |
| | wax | | |
| PLC(SR297)-72 | 1,3 Butylene Glycol | 4 | 1.1 |
| | Dimethacrylate Esters | | |
| VULCUP 40KE | Di(2-tert-butylperoxyiso- | 4 | 1.1 |
| | propyl) benzene | | |
| Total | | 352.55 | 100 |
| Sp. Gr. | | 1.27 | |

TABLE 2
PROPERTIES OF COMPOUNDED BLACK RUBBER

| Test | Test Method | Property Range |
|---|---|---|
| 100% Modulus | ASTM D412 | 0.62 (90)-2.07 (300) |
| MN/sq. meter (psi) | | |
| 200% Modulus | ASTM D412 | 0.83 (120)-4.13 (600) |
| MN/sq. meter (psi) | | |
| 300% Modulus | ASTM D412 | 1.72 (250)-5.51 (800) |
| MN/sq. meter (psi) | | |
| Tensile at Break | ASTM D412 | 6.90 (1000)-15.16 (2200) |
| MN/sq. meter (psi) | | |
| Elongation at Break | ASTM D412 | 700%-1200% |
| Shore A Hardness | ASTM D2240 | 40-55 |

Table 3 and Table 4

Table 3 provides a typical composition for an elastomeric rubber used for the outer wall of identifier sleeves according to the present invention. Optimization of elastomeric rubber compositions requires variation of components to provide extruded materials having desired properties of modulus, elongation at break, and ability to form strong interfacial bonds with compatible, co-extruded elastomeric rubbers. Table 4 provides preferred test methods for property measurement and typical ranges for selected properties of co-extrudable elastomeric rubbers used for outer layers of marker sleeves.

TABLE 3
COLORED RUBBER FORMULATION

| | | Rubber | Component |
|---|---|---|---|
| Commercial Identity | Chemical Identity | phr | wt % |
| BUNA EPT 6850 | EPDM Rubber | 75 | 21.5 |
| BUNA EPT 5459 | EPDM Rubber | 50 | 14.4 |
| VANOX ZMTI | Zinc 2-mercapto | 1.25 | 0.4 |
| | tolumimidazole | | |
| SUNFAST YELLOW 13 | Pigment Yellow 13 | 0.6 | 0.2 |
| STRUKTOL WB-16 | Proprietary mixture | 2 | 0.6 |
| Zinc Oxide | Zinc Oxide | 5 | 1.4 |
| HISIL 532 EP | Hydrated Amorphous | 60 | 17.2 |
| | Silica | | |
| NYACOL ZTA | Antimony Pentoxide | 20 | 5.7 |
| GREAT LAKES DP-45 | Bis(2-ethylhexyl) | 120 | 34.5 |
| | tetrabromophthalate | | |
| ZINC OMADINE | Bis(1-hydroxy-2(1H)- | 0.3 | 0.1 |
| | pyridine thionato- | | |
| | O,S)-(T-4) Zinc | | |
| EF(VTMO)-50 | Silane in hydrocarbon | 2 | 0.6 |
| | wax | | |
| Titanium Dioxide | Titanium dioxide | 4 | 1.1 |
| PLC(SR297)-72 | 1,3 Butylene Glycol | 4 | 1.1 |
| | Dimethacrylate Esters | | |
| VULCUP 40KE | Di(2-tert-butylperoxy- | 4 | 1.1 |
| | isopropyl) benzene | | |
| Total | | 348.15 | 100 |
| Sp. Gr. | | 1.27 | |

TABLE 4
PROPERTIES OF COMPOUNDED COLORED RUBBER

| Test | Test Method | Property Range |
|---|---|---|
| 100% Modulus | ASTM D412 | 0.48 (70)-2.07 (300) |
| MN/sq. meter (psi) | | |
| 200% Modulus | ASTM D412 | 0.69 (100)-4.13 (600) |
| MN/sq. meter (psi) | | |
| 300% Modulus | ASTM D412 | 1.17 (170)-5.51 (800) |
| MN/sq. meter (psi) | | |
| Tensile at Break | ASTM D412 | 6.75 (980)-15.16 (2200) |
| MN/sq. meter (psi) | | |
| Elongation at Break | ASTM D412 | 600%-1200% |
| Shore A Hardness | ASTM D2240 | 38-55 |

Table 5

Table 5 provides a typical ranges of properties for dual wall extruded tubes using the black inner wall and the yellow outer wall compositions of the type previously described. As expected, there was strong interfacial bonding between layers of sleeve identifiers, which were successfully stretched and held in an expanded condition on rigid support cores for future application to wires and cables and the like.

TABLE 5
PROPERTIES OF TUBING FOR SLEEVE IDENTIFIERS

| Test | Test Method | Property Range |
|---|---|---|
| 100% Modulus | ASTM D412 | 0.62 (90)-2.07 (300) |
| MN/sq. meter (psi) | | |
| 200% Modulus | ASTM D412 | 0.83 (120)-4.13 (600) |
| MN/sq. meter (psi) | | |
| 300% Modulus | ASTM D412 | 1.72 (250)-5.51 (800) |
| MN/sq. meter (psi) | | |
| Tensile at Break | ASTM D412 | 6.90 (1000)-15.16 (2200) |
| MN/sq. meter (psi) | | |
| Elongation at Break | ASTM D412 | 700%-1200% |
| Shore A Hardness | ASTM D2240 | 38-55 |

Sample Sleeve Identifier

A co-extruded tube was prepared as described previously to provide a dual-wall composite tube having an outer yellow wall 375 μm (15 mils) thick surrounding a thicker inner wall that was about 2.2 mm (87 mil) thick. Using the formulas for the black composition and yellow composition shown in Tables 1 and 3, there was strong bond formation at the interface between the yellow and the black layer, under the conditions used for co-extrusion of the dual-wall tube. Strong bonding was also observed during formation of laminated test coupons using sheets of black and yellow elastomers. Attempts to separate the layers of either the extruded tubing or laminated sheets, by peeling, were unsuccessful preventing determination of interlayer bond strength. Application of force to achieve separation caused test samples to tear. This result suggests that sleeve identifiers according to the present invention will fail by tearing or rupturing rather than inter-wall separation. Based on this observation the bonding between layers is very good and should not be affected during stretching of the rubber. Inspection of samples for elongation at break showed no evidence of separation of layers, at the break line, after testing. Table 6 includes properties of the sample sleeve identifier.

TABLE 6
PROPERTIES OF A SLEEVE IDENTIFIER SAMPLE

| Test | Test Method | Property Range |
|---|---|---|
| 100% Modulus | ASTM D412 | 0.77 (112) |
| MN/sq. meter (psi) | | |
| 200% Modulus | ASTM D412 | 1.65 (240) |
| MN/sq. meter (psi) | | |
| 300% Modulus | ASTM D412 | 2.93 (425) |
| MN/sq. meter (psi) | | |
| Tensile at Break | ASTM D412 | 10.74 (1559) |
| MN/sq. meter (psi) | | |
| Elongation at Break | ASTM D412 | 713% |
| Shore A Hardness | ASTM D2240 | 38-55 |

Conditions for Laser Ablation

Sleeve identifiers according to the present invention may be processed either before or after placement in an expanded condition on rigid support cores. Preferably an identifying mark is formed in the outer wall of a marker sleeve using the power of a laser to ablate material from the outer layer to reveal the contrasting color of an inner layer. Laser marking has been performed using several different types of laser including YAG lasers and CO₂ lasers. A CO₂ laser is more effective than a YAG laser for removing the elastomeric rubber materials used in sleeve identifiers. Preferably the laser operates at a power of 100 watts for a time to provide identifying marks of sufficient contrast and legibility for easy reading and scanning with automatic detection equipment.

As mentioned previously, compositions of marker sleeves according to the present invention contain no lead or similar heavy metal compounds or toxic substances that could create an environmental hazard by vaporizing during use of the process of laser ablation to form identifying marks. Production of multi-wall tubing including walls of non-uniform thickness is also undesirable since image symbols are cut to a consistent depth by process of laser ablation and a change in wall thickness could compromise image legibility. Image stability and legibility will be affected by the way in which coloring materials react to the environment that may contain liquid and gaseous agents and contaminants. Colored pigments appear beneficial for improved color and stability to potential environmental contaminants including fuel, oil, chemicals, and oxidants and the like.

As required, details of identifier sleeves according to the present invention are disclosed herein, however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

What is claimed is:

1. A tubular article comprising:
a dual-wall extruded tube including an elastomeric outer wall having a first color and an elastomeric inner wall having a second color, said dual-wall extruded tube formed by co-extrusion of said elastomeric outer wall and said elastomeric inner wall to provide a bond between said elastomeric outer wall and said elastomeric inner wall, said tubular article having visible indicia formed therein by removal of selected portions of said elastomeric outer wall using laser ablation to reveal said second color of said elastomeric inner wall, said first color differing from said second color to provide high contrast of said indicia from said first color of said elastomeric outer wall, said tubular article being expandable for placement on a core member in an expanded condition wherein said bond between said elastomeric outer wall and said elastomeric inner wall remains substantially unchanged.

2. The tubular article of claim 1, wherein said elastomeric outer wall comprises at least one elastomer selected from the group consisting of vulcanized elastomers and thermoplastic elastomers.

3. The tubular article of claim 2, wherein said at least one elastomer is selected from the group consisting of ethylene propylene diene monomer (EPDM) rubbers, silicone elastomers, fluorosilicone elastomers, fluoro-elastomers, and mixtures thereof.

4. The tubular article of claim 1, wherein said first color is provided by a colored pigment.

5. The tubular article of claim 4, wherein said colored pigment is selected from the group consisting of white and yellow colored pigments.

6. The tubular article of claim 1, wherein said elastomeric inner wall comprises at least one elastomer selected from the group consisting of vulcanized elastomers and thermoplastic elastomers.

7. The tubular article of claim 6, wherein said at least one elastomer is selected the group consisting of ethylene propylene diene monomer (EPDM) rubbers, silicone elastomers, fluorosilicone elastomers, fluoro-elastomers, and mixtures thereof.

8. The tubular article of claim 1, wherein said second color is provided by a colored pigment.

9. The tubular article of claim 4, wherein said colored pigment is carbon black.

10. The tubular article of claim 1, having an elongation of 300% by application of force from about 1.72 MN/sq. meter (250 psi) to about 5.51 MN/sq. meter (800 psi).

11. The tubular article of claim 1, further having a tensile strength at break from about 6.90 MN/sq. meter (1000 psi) to about 15.16 MN/sq. meter (2200 psi).

12. The tubular article of claim 1, wherein said elastomeric outer wall has a thickness from about 250 μm (10 mils) to about 625 μm (25 mils) and said elastomeric inner wall has a thickness from about 1.88 mm (75 mils) to about 3.75 mm (150 mils).

13. A tubular article comprising:
a multi-wall extruded tube including an elastomeric outer wall having a first color and at least one elastomeric inner wall having a second color, said multi-wall extruded tube formed by co-extrusion to provide interlayer bonding including said elastomeric outer wall and said at least one elastomeric inner wall, said tubular article having visible indicia formed therein by removal of selected portions of said elastomeric outer wall using laser ablation to reveal said second color of said at least one elastomeric inner wall, said first color differing from said second color to provide high contrast of said indicia from said first color of said elastomeric outer wall, said tubular article being expandable for placement on a core member in an expanded condition wherein said interlayer bonding remains substantially unchanged.

14. A cold-shrink article comprising:
a support core adapted to become a collapsed core; and
a multi-wall elastic tube held in an expanded condition on said support core, said multi-wall elastic tube including an elastomeric outer wall having a first color and at least one elastomeric inner wall having a second color, said multi-wall elastic tube formed by co-extrusion to provide interlayer bonding including said elastomeric outer wall and said at least one elastomeric inner wall, said multi-wall elastic tube having visible indicia formed therein by removal of selected portions of said elastomeric outer wall using laser ablation to reveal said second color of said at least one elastomeric inner wall, said first color differing from said second color to provide high contrast of said indicia from said first color of said elastomeric outer wall, said multi-wall elastic tube in said expanded condition maintaining said interlayer bonding substantially unchanged, said multi-wall elastic tube shrinking as said support core becomes said collapsed core.

15. The cold-shrink article of claim 14, wherein said elastomeric outer wall comprises at least one elastomer selected from the group consisting of ethylene propylene diene monomer (EPDM) rubbers, silicone elastomers, fluorosilicone elastomers, fluoro-elastomers, and mixtures thereof.

16. The cold-shrink article of claim 14, wherein said at least one elastomeric inner wall comprises at least one elastomer selected from the group consisting of ethylene propylene diene monomer (EPDM) rubbers, silicone elastomers, fluorosilicone elastomers, fluoro-elastomers, and mixtures thereof.

17. The cold-shrink article of claim 14, wherein said multi-wall elastic tube has an elongation of 300% by application of force from about 1.72 MN/sq. meter (250 psi) to about 5.51 MN/sq. meter (800 psi).

18. The cold-shrink article of claim 14, wherein said multi-wall elastic tube has a tensile strength at break from about 6.90 MN/sq. meter (1000 psi) to about 15.16 MN/sq. meter (2200 psi).

19. The cold-shrink article of claim 14, wherein said elastomeric outer wall has a thickness from about 250 μm (10 mils) to about 625 μm (25 mils) and said at least one elastomeric inner wall has a thickness from about 1.88 mm (75 mils) to about 3.75 mm (150 mils).
